(19) United States
(12) Patent Application Publication
(10) Pub. No.: US 2026/0163974 A1
(43) Pub. Date: Jun. 11, 2026

(54) PRIORITIZING TELECOMMUNICATIONS SUBSCRIBERS BASED ON COLLECTED TELECOMMUNICATIONS DATA

(71) Applicant: T-MOBILE INNOVATIONS LLC, Overland Park, KS (US)

(72) Inventors: Yousef ALABSSI, Parsippany, NJ (US); Belkacem MOUFFOK, Parsippany, NJ (US)

(21) Appl. No.: 18/970,180

(22) Filed: Dec. 5, 2024

(51) Int. Cl. H04M 3/22; G06F 21/60; G06Q 30/0251; H04M 3/42

(52) U.S. Cl. CPC H04M 3/2218; G06F 21/602; G06Q 30/0251; H04M 3/2254; H04M 3/4217; H04M 3/42187

(57) ABSTRACT

Systems and methods are provided for managing telecommunications subscribers based on their connectivity score within a network environment. This social interaction data is used to optimize various telecommunication functions such as targeted marketing, customer service prioritization, and network resource allocation.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for assigning scores and prioritizing subscribers based on their interactions with other subscribers to evaluate their influence or connectivity within the telecommunications network. More particularly, subscribers having more frequent, longer, or more influential communications might receive higher “connectivity” scores. The system may use these scores for various purposes, such as identifying key influencers within the network, optimizing marketing strategies, and/or improving network services for highly connected subscribers.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached figures, which are intended to be exemplary and non-limiting, wherein:

FIG. 1 depicts a diagram of an exemplary network environment, in accordance with aspects herein;

FIG. 2 illustrates a graph with the social connections between telecommunications subscribers, in accordance with aspects herein;

FIG. 3A illustrates a graph with the social connections between telecommunications subscribers, in accordance with aspects herein;

FIG. 3B illustrates a graph with the social connections between telecommunications subscribers, in accordance with aspects herein;

FIG. 4 depicts a flow diagram of an exemplary method for a telecommunications network to prioritize telecommunications subscribers based on collected data, in accordance with aspects herein; and

FIG. 5 depicts a diagram of an exemplary computing environment, in accordance with aspects herein.

### DETAILED DESCRIPTION

The subject matter, in aspects, is provided with specificity herein to meet statutory requirements. However, the description itself is not intended to limit the scope of this patent. Rather, it is contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

By way of background, in the current telecom network infrastructure, subscribers are typically analyzed and managed for marketing purposes based on individual data points such as usage patterns, demographics, and billing history. As such, telecommunication providers often segment their customer base into broad categories—such as high data users, frequent callers, or long-term subscribers—and tailor marketing efforts to these predefined groups. This segmentation allows providers to push specific offers, promotions, or upgrades to customers who meet certain criteria. For example, users nearing their data cap may receive notifications for data plan upgrades, or long-term subscribers may be offered loyalty rewards.

However, this conventional approach lacks precision. The current marketing efforts are based on isolated behaviors and demographic factors rather than taking into account the social dynamics between telecommunications subscribers. For example, a user who consistently interacts with others may exert significant influence over their contacts'decisions, yet the current prioritization system does not account for this. Marketing campaigns typically cast a wide net, targeting individual users based on their own behavior rather than recognizing users who could serve as catalysts for broader adoption within their social circles.

Without understanding the influence certain subscribers have over others, telecommunication providers miss opportunities for more effective marketing strategies. For example, a marketing campaign might push a new data plan to all high-data users, but it would be more efficient to first target subscribers who are socially connected to others, knowing that their adoption of the plan might encourage their peers to follow suit.

Aspects provided herein utilize telecommunications data (i.e., call records, SMS logs, and/or data usage patterns) to determine a connectivity score for the subscriber. Particularly, the telecommunications data can be processed and quantified based on several metrics, including the number of contacts a subscriber regularly interacts with, the strength of those interactions, and any resulting behaviors (e.g., service adoption or plan upgrades). A subscriber with a high score might be considered an influencer within the network, capable of driving others to adopt services or behaviors.

Rather than broadcasting marketing campaigns broadly, telecommunications providers could focus their efforts on high-influence users or subscribers. These high-influence subscribers may receive tailored offers or incentives to promote new services, knowing that their adoption would likely encourage others to follow. For example, a subscriber who regularly communicates with ten or more users might be given a discount for referring friends to the service, capitalizing on their central role in the network. By prioritizing customer support based on connectivity scores, providers can allocate resources more efficiently. In aspects, when a high-influence subscriber contacts support, they may receive priority handling to ensure any issues are resolved promptly, reducing the risk of dissatisfaction spreading through their social circle. Additionally, proactive outreach—such as offering upgrades or personalized support—may be directed toward key influencers to keep them satisfied. In various aspects, using social interaction data, telecommunications providers can improve the precision of network upgrades or maintenance. Furthermore, high-interaction zones (e.g., dense clusters of socially connected users) may be identified and prioritized for enhanced capacity or reduced latency, ensuring that these socially active areas remain well-served.

As used herein, the term “cell site,” may include an “access point,” “node,” or “base station” refer to a centralized component or system of components that is configured to wirelessly communicate (receive and/or transmit signals) with a plurality of stations (i.e., wireless communication devices, also referred to herein as user equipment (UE(s))) in a geographic service area. A cell site suitable for use with the present disclosure may be terrestrial (e.g., a fixed/non-mobile form such as a macro cell site or a utility-mounted small cell) or may be extra-terrestrial (e.g., an airborne or satellite form such as an airship or a satellite).

The terms “user device,” “user equipment,” “UE,” “mobile device,” “mobile handset,” and “mobile transmitting element” all describe a mobile station and may be used interchangeably in this description.

The terms “GPS,” “global positioning system,” and “location information” may be used interchangeably to describe methods to determine or calculate exact location. Another such method used to calculate location information, may involve utilizing the serving beam, the OTDOA (observed time difference of Arrival) techniques, as well of AoA (Angle of Arrival) of UE signals to precisely calculate the position of a user utilizing solely the telecommunication network. Certain terminology may be used to differentiate access points and/or antenna arrays from one another; for example, a combination access point may be used to describe an access point having a primary antenna array and a redundant antenna array that have different orientations (i.e., configured to serve different geographic areas), distinguished from a traditional access point which may be used to describe an access point comprising a single antenna array used to communicate to a single geographic area.

Accordingly, a first aspect of the present disclosure is directed to a method for prioritizing telecommunications subscribers based on collected data, the method comprising collecting and encrypting telecommunications data comprising voice call metadata. The method also includes processing the telecommunications data to determine a connectivity score, wherein the connectivity score is based on a frequency of interactions between each subscriber and one or more other subscribers within a predetermined timeframe. The method also includes applying the connectivity score to a subscriber's profile.

A second aspect of the present disclosure is directed to a system for prioritizing telecommunications subscribers based on collected data, the system comprising one or more processors and one or more computer-readable media storing computer-usable instructions that, when executed by the one or more processors, cause the one or more processors to collect and encrypt telecommunications data comprising user equipment (UE) communication metadata. The system also includes processing the telecommunications data to determine a connectivity score, wherein the connectivity score is based on a frequency of interactions between each subscriber and one or more other subscribers within a predetermined timeframe. The system also includes applying the connectivity score to a subscriber's profile.

A third aspect of the present disclosure is directed to a computer-readable storage media having computer-executable instructions embodied thereon that, when executed by one or more processors, cause the one or more processors to collect and encrypt telecommunications data comprising user equipment (UE) communication metadata. The computer-readable storage media also includes processing the telecommunications data to determine a connectivity score, wherein the connectivity score is based on a frequency of interactions between each subscriber and one or more other subscribers within a predetermined timeframe. The computer-readable storage media also includes applying the connectivity score to a subscriber's profile.

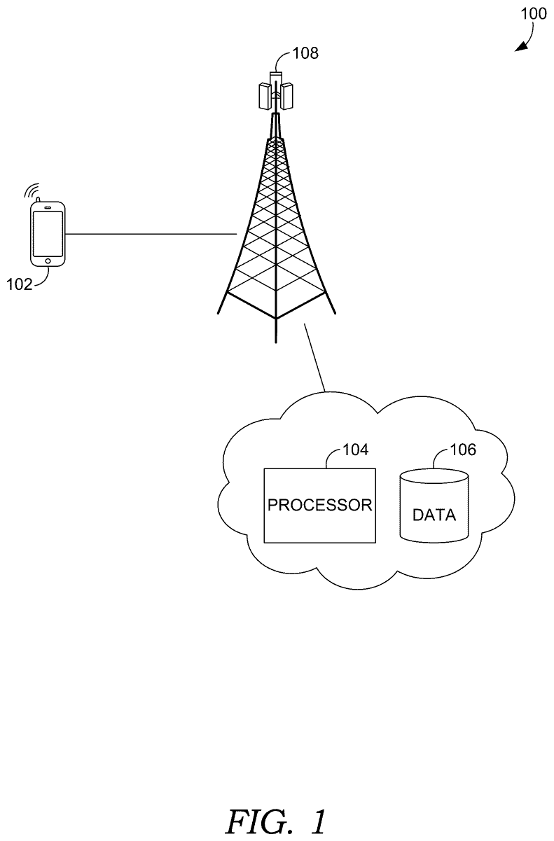

Turning now to FIG. 1 an exemplary network environment is illustrated in which implementations of the present disclosure may be employed. Such a network environment is illustrated and designated generally as network environment 100. Network environment 100 is but one example of a suitable network environment and is not intended to suggest any limitation as to the scope of use or functionality of the invention. Neither should the network environment be interpreted as having any dependency or requirement relating to any one or combination of components illustrated.

Network environment 100 generally includes a cell site 108, a user device 102, and a processor 104 that are communicatively coupled with each other. Though illustrated as a macro site, the cell site 108 may be a macro cell, small cell, femto cell, pico cell, or any other suitably sized cell, as desired by a network carrier for communicating within a particular geographic area utilizing any range of frequencies for communication. In aspects, such as the one illustrated in FIG. 1, the cell site 108 may comprise one or more nodes (e.g., NodeB, eNodeB, ng-eNodeB, gNodeB, en-gNodeB, and the like) that are configured to communicate with a plurality of UEs (e.g., 102) in one or more discrete geographic areas using one or more antennas of an antenna array. In the aspect illustrated in FIG. 1, the cell site 108 provides a coverage to a plurality of UEs (e.g., 102). For the purposes of the present disclosure, the UE 102 may utilize a wireless data connection to communicate with the cell site 108.

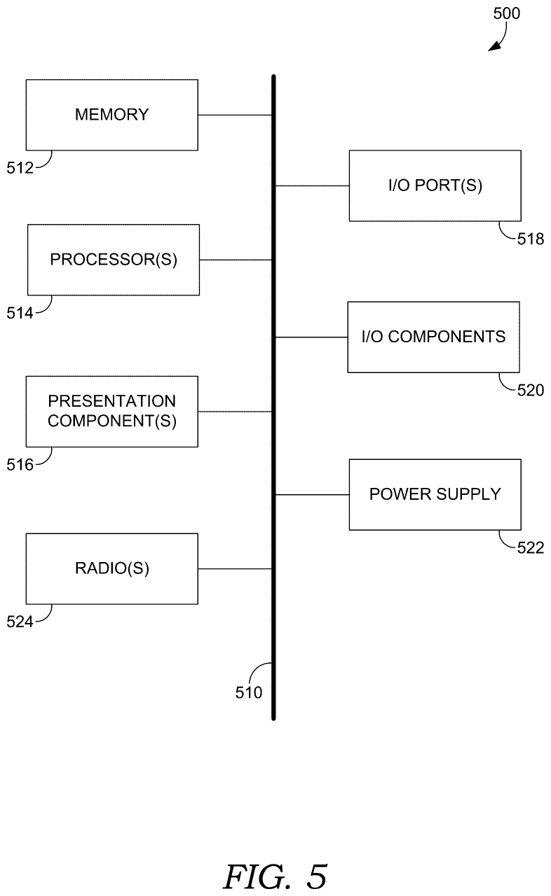

User device 102 may comprise any type of computing device capable of use by a user. For example, in one aspect, user device 102 may be the type of computing device described in relation to FIG. 5 herein. By way of example and not limitation, a user device may be embodied as a personal computer (PC), a laptop computer, a device, a smartphone, a tablet computer, a smart watch, a wearable computer, a fitness tracker, a virtual reality headset, augmented reality glasses, a personal digital assistant (PDA) device, a global positioning system (GPS) or device, a video player, a handheld communications device, a gaming device or system, an entertainment system, a vehicle computer system, an embedded system controller, a camera, a remote control, an appliance, a consumer electronic device, a workstation, or any combination of these delineated devices, a combination of these devices, or any other suitable computer device.

The user device 102 may be equipped with an agent, for example, embodied as a specially designed hardware for identifying influence of users, a browser plug-in, a specially designed computer program or application operating on a user device, across multiple devices, or in the cloud, for identifying influence of users, or a computing service running in the cloud to implement one or more of the technical solutions discussed herein for identifying influence of users.

In one aspect, the agent or any other component within the user device 102 works in synergy with the processor 104 to enable identification of influential users by sending and/or receiving information from the processor 104 as well as executing instructions provided by the processor 104. The processor 104 can enable identification of influential users. In some embodiments, the processor could be a stand-alone server device. In other embodiments, the processor 104 may be implemented as services in a computing cloud. In various aspects, the processor 104 may include a connection handler, a confidence level handler, a calculator, a ranker, a generator, etc. Additionally, processor 104 may comprise a data store or be in communication with a separate data store such as data store 106.

As mentioned above, the present system 100 does not need to identify a type of connection between users. The system 100 can identify that connections are the same or different without identifying the specific type of connection. The system 100 can identify explicit connections, implicit connections, or a combination thereof. An explicit relationship, as used herein, refers generally to a direct relationship between a user and another user. An implicit relationship, as used herein, refers generally to an indirect relationship between two users that are not directly connected, but are connected using an intermediate connection/user. A connection handler, for instance, may be configured to identify explicit connections, implicit connections, and the like. The connection handler can derive multiple types of connections (or relationships) implicitly from user behavior and construct a heterogeneous social network with estimated influence.

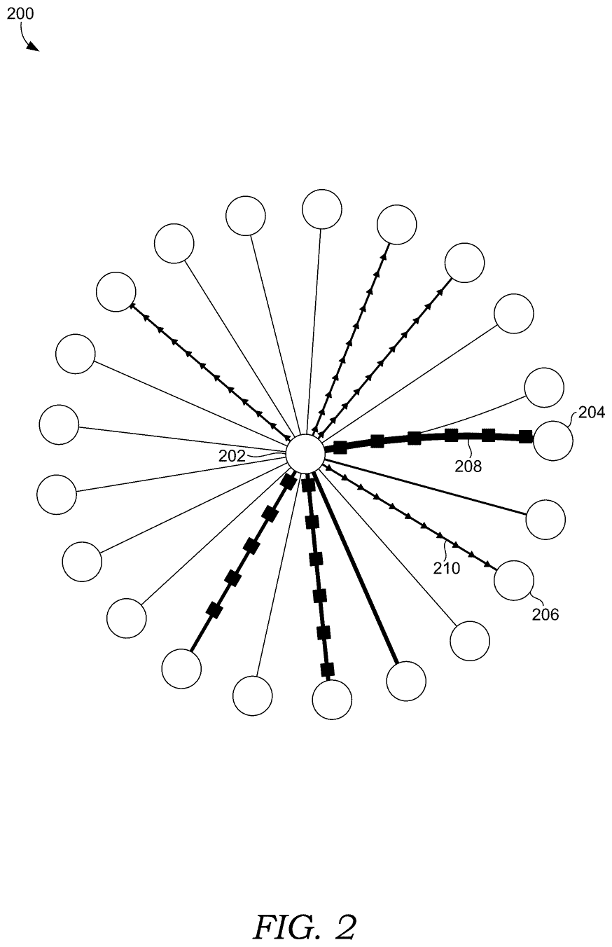

Turning to FIG. 2, a graph 200 is illustrated showing the social connections between a particular telecommunications subscriber and the people they communicate with using their telecommunications device (e.g., user device 102). In aspects, the communication metadata (hereinafter referred to as “metadata”) of user device 102 is collected. This metadata may comprise voice call metadata, including a call duration and a time of the call. In other aspects, this metadata may comprise text message data, including the frequency of text messages received and sent. This metadata may be collected at various intervals such as daily, weekly, or monthly. Once collected, the metadata is encrypted to ensure the privacy and security of the subscriber's data.

Next, a visual link is created between the subscriber and their contacts using a social connection graph. This graph compiles all of the collected metadata from the user device 102 and constructs a visual representation of the subscriber's relationships with others. The graph 200 consists of nodes and edges, where each node represents a different subscriber that is connected to the subscriber owning user device 102 and each edge represents a call or text interaction between the subscribers.

In aspects, subscriber node 202 represents the primary subscriber whose call records are being analyzed in this example (e.g., user device 102). From subscriber node 202, edges extend to other nodes, such as a first node 204 and a second node 206, which represent the subscriber's contacts or any user for which the subscriber node 202 has been in contact. The edges may vary in thickness, color, and design to convey different types of information about the interactions. In one embodiment, the thickness of an edge indicates a frequency of communication between the two connected nodes. For example, a first edge 208 is thicker than a second edge 210. In aspects, the thicker edge of the first edge 208 represents a higher frequency of communication between the subscriber node 202 and the first node 204, indicating a strong connection. Conversely, the second edge 210 is thinner compared to the first edge 208, and represents a lower frequency of communication between the subscriber node 202 and the second node 206, indicating a weaker connection.

In another embodiment, the one or more processors may collect both outgoing and incoming communication data for each subscriber to determine the directionality of the communication. The design of the edges may distinguish between unidirectional and bidirectional communication. For example, an edge with blocks (e.g., the first edge 208) may indicate bidirectional calls, where both parties initiate calls to each other, while an edge with triangles/arrows (e.g., the second edge 210) may indicate unidirectional calls, where only one party initiates the calls. In other embodiments, the edges may be designs other than blocks and triangles. For example, the edges could have circles, stars, diamonds, and the like to distinguish different types of communication. In other examples, the edges could be different colors to differentiate the communications.

Although all of the nodes in FIG. 2 are the same size for simplicity, in various aspects, the size of the nodes may reflect the influence of the subscriber, with larger nodes indicating a higher influence, and therefore a higher connectivity score. This connectivity score may be calculated based on the frequency of interactions between the subscriber and other subscribers within a predetermined timeframe. As used herein, the term frequency is the number of interactions between users in a predetermined period of time. For example, if the subscriber node 202 were larger in size than another subscriber node, it would suggest that subscriber node 202 has a high level of interaction with multiple other subscribers, suggesting subscriber node 202 may be a potential influencer within the network 100.

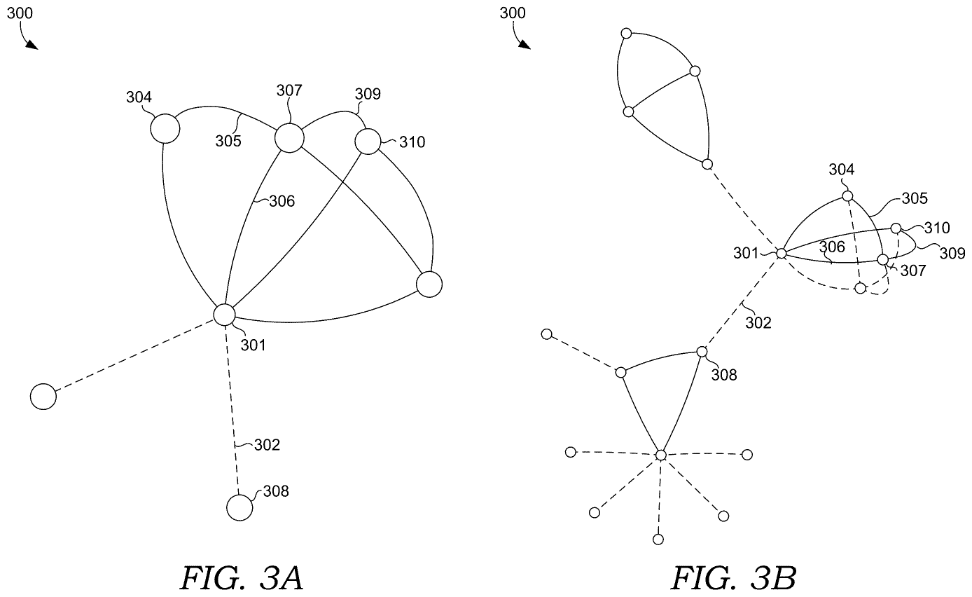

In yet another embodiment, the graph 200 may be used to identify patterns and trends in subscriber behavior. For example, if the subscriber node 202 frequently communicates with several other particular nodes that also have high connectivity scores, it may indicate a cluster of influential subscribers within a plurality of subscriber profiles (illustrated in FIGS. 3A and 3B). This information may be valuable for telecommunications companies to target marketing efforts or improve network services. Based on the connectivity score, the plurality of subscriber profiles with the higher connectivity score may be prioritized. For example, subscribers with higher connectivity scores may receive a higher priority for targeted marketing or service promotions from the telecommunications carrier.

Additionally, the processed data illustrated by FIGS. 2 and 3A-3B, that is used to determine the connectivity score, may include assigning a higher weight to connections involving a number of interactions that exceeds a predetermined interaction threshold or a time of interactions that exceeds a predetermined time threshold. The predetermined time threshold may refer to a specific duration of interaction that distinguishes significant engagements. For example, in embodiments, the threshold may consider the length of a call or interaction, such as a call lasting 10 minutes as being weighted more heavily than a call lasting only 1 minute. This weighting emphasizes sustained engagements, which may be indicative of stronger or more influential connections. This prioritization ensures that influential subscribers are more likely to receive special offers, new service plans, or exclusive promotions, thereby enhancing customer engagement and satisfaction.

Additionally, the graphs 200 and 300 may be dynamically updated as new communication metadata is collected. In aspects, this allows for real-time analysis of subscriber connections and the identification of emerging influencers. For example, if a previously low-connectivity node suddenly starts receiving a high volume of calls, it can quickly be identified and analyzed for potential changes in influence. Furthermore, the network 100 may generate alerts when a subscriber's connectivity score exceeds a predefined threshold, indicating a high level of network activity.

Alternative examples of network graphs 300 are depicted in FIGS. 3A and 3B. Different types of connections are illustrated in these figures. For example, a first type of connection (e.g., a “voice call” connection) is shown in FIG. 3A, and a second type of connection (“text message” connection) is shown in FIG. 3B. Each node represents a telecommunications subscriber, and the terms may be used interchangeably herein. For example, in FIGS. 3A and 3B, node 301, node 304, node 307, and node 308 each represent a different subscriber. The connections between subscribers are represented by edges. For example, edge 305 is a connection between subscriber 304 and subscriber 307, while edge 306 is a connection between subscriber 307 and subscriber 301. For example, an explicit connection exists between subscriber 304 and subscriber 307 via edge 305 (e.g., a direct voice call), while an implicit connection between subscriber 304 and subscriber 310 may be inferred through their mutual connection to subscriber 307 via edges 305 and 309. In aspects, dashed edge 302 represents a second connection type between subscriber 301 and subscriber 308 where subscriber 308 is in a different telecommunications network.

The influence values discussed above with respect to the telecommunications network may be identified and/or computed by one or more of a confidence level handler, a calculator, or any other component or instruction configured to compute influence values as described herein. In particular, an overall connectivity score is computed to identify subscribers having a large influence over other subscribers or the behavior of other subscribers. The overall connectivity score may be computed using a confidence level and an influence ability score.

A confidence level may be assigned to a subscriber based on validation metrics. Validation metrics may comprise product adoptions or any additional subscriber behaviors that may be attributed to another subscriber. A validation metric may be referred to as any subscriber behavior that is within a predetermined period of time of the same behavior from a different subscriber. An exemplary validation metric may be, as mentioned, a service adoption. For example, if Subscriber A is connected with Subscriber B and shortly after Subscriber A subscribes to a new data plan, then Subscriber B also subscribes to the same data plan, the service adoption by Subscriber B may be attributed to Subscriber A's influence. This is merely one example of how a behavior of a subscriber connected to others is evaluated.

An influence ability score represents how many connections a subscriber has and how strong they are. Thus, a number of connections for a particular subscriber may be identified along with a weight of the connection. In particular, the influence ability score is computed by identifying an importance score for the subscriber that represents the significance of their interactions within the telecommunications network. This score may be determined by categorizing subscriber interactions based on the type of communication, including voice call types and text message types. The connections of the subscriber are then weighted based on the frequency and duration of calls, as well as the number of unique subscribers they interact with. For example, a subscriber who frequently communicates with many different subscribers and has long call durations would have a higher importance score. Similarly, the frequency of text messages can also be considered. A subscriber who sends and receives a large number of text messages, especially with many different subscribers, may also have a higher importance score. The system applies a weighting component to different types of communications, wherein voice call types and text message types contribute differently to the connectivity score. Once weighted, these importance scores are aggregated to identify the overall influence ability score. Each connection may have a different importance score based on these factors.

The overall influential scores may be utilized among subscribers by, for instance, a ranker, to rank multiple subscribers according to influence. The ranking may, in turn, be used to generate personalized content for influential subscribers (by, for instance, a generator). For example, if a subscriber is ranked very high in terms of influence, the subscriber may be identified as a target for particular telecommunications services or promotions. This could include special offers on data plans, new device upgrades, or exclusive service bundles. The goal is to either invoke an action in the subscriber that may be mimicked by others or to increase the likelihood that others connected to that subscriber will see and be influenced by the content as well.

Since subscribers in the heterogeneous network are connected by different types of relationships, instead of consolidating the relationships, the system preserves the heterogeneous nature of the network and uses pseudo-feedback to gauge the influence flow. Intuitively, the influence flow is different through different types of connections. More specifically, the correlation between the connection type and a validation metric (e.g., service adoption) is used to estimate the weight of each connection type. For example, the system might weigh voice call connections more heavily if they are found to be more predictive of service adoption compared to text message connections.

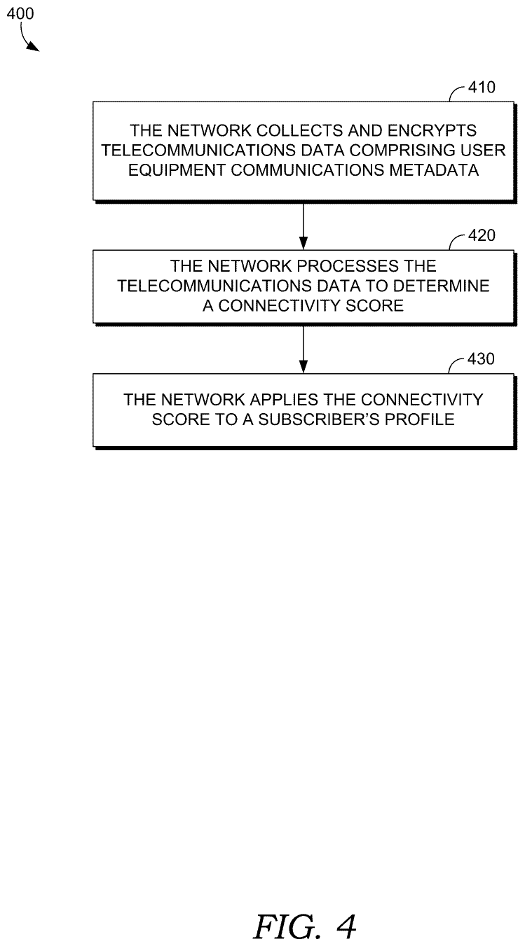

Turning now to FIG. 4, a flowchart is provided of a method 400 for prioritizing telecommunications subscribers based on collected data. Initially, at block 410, the network collects and encrypts telecommunications data comprising user equipment communications metadata. At block 420, the network processes the telecommunications data to determine a connectivity score, wherein the connectivity score is based on a frequency of interactions between each subscriber and one or more other subscribers within a predetermined timeframe. At block 430, the network applies the connectivity score to a subscriber's profile.

In other aspects, a machine learned model (i.e., artificial intelligence (AI)), trained using telecommunications data, can be implemented to refine the connectivity score estimation. The AI system can use a range of techniques, encompassing supervised, unsupervised, and semi-supervised learning. This incorporates a multitude of algorithms, such as decision trees, neural networks, clustering methods, and the like. The AI system consists of several input and output points. These points, or nodes, represent specific data features, undergoing various mathematical processes. Certain components (e.g., call duration, frequency of interactions) provide these data features and form the AI's decision basis. Prior to feeding data into the AI's training mechanisms, a preprocessing phase refines the input. This phase can involve tasks such as data cleansing, normalization, and scaling, to ensure data consistency and quality.

The AI system can also undergo feature extraction processes, which streamline and simplify the vast amounts of input data. This extraction determines the most critical data aspects and ensures efficient machine learned model performance. Several feature extraction methodologies may be used, ranging from statistical methods to algorithm-based techniques. These methodologies aim to present the most relevant data in an efficient manner for the AI to process. The preprocessing phase may also tackle challenges such as missing data. Another facet of preprocessing involves identifying and managing outliers to ensure they do not skew the AI's decision-making process. Another component of preprocessing is feature scaling, which harmonizes data scales and ensures no single data type disproportionately influences the AI's operations. Feature selection is another crucial phase, focusing on pinpointing the most relevant data attributes for the AI's learning process. This phase can leverage various techniques to determine the data's most critical aspects.

Once preprocessing is complete, the AI undergoes training. During this phase, the system repeatedly processes the data, refining its internal parameters for the best performance. After training, the AI is deployed to handle real-world data (i.e., connectivity score estimation). The AI can translate this data into a format it understands, utilizing the patterns it recognized during its training phase.

With reference to FIG. 5, the computing device 500 includes a bus 510 that directly or indirectly couples the following devices: a memory 512, one or more processor(s) 514, one or more presentation component(s) 516, input/output (I/O) port(s) 518, I/O components 520, an illustrative power supply 522, and radio(s) 524. The bus 510 represents what may be one or more busses (such as an address bus, a data bus, or a combination thereof). Although various blocks of FIG. 5 are shown with lines for the sake of clarity, in reality, delineating various components is not so clear, and metaphorically, the lines would more accurately be grey and fuzzy. For example, one may consider a presentation component, such as a display device, to be an I/O component. The inventor recognizes that such is the nature of the art and reiterates that the diagram of FIG. 5 is merely illustrative of an example computing device that may be used in connection with one or more embodiments of the present disclosure. Distinction is not made between such categories as “workstation,” “server,” “laptop,” “hand-held device,” etc., as all are contemplated within the scope of FIG. 5 and with reference to the term “computing device.”

The computing device 500 typically includes a variety of computer-readable media. The computer-readable media may be any available media that may be accessed by the computing device 500 and includes both volatile and nonvolatile media, and removable and non-removable media. By way of non-limiting example, the computer-readable media may comprise computer storage media and communication media. The computer storage media includes both volatile and nonvolatile, removable, and non-removable media implemented in any method or technology for storage of information, such as computer-readable instructions, data structures, program modules or other data. The computer storage media includes, but is not limited to, random-access memory (RAM), read-only memory (ROM), electronically erasable programmable read-only memory (EEPROM), flash memory or other memory technology, compact disc read-only memory (CD-ROM), digital versatile disks (DVDs) or other optical disk storage, magnetic cassettes, magnetic tape, magnetic disk storage or other magnetic storage devices, or any other medium which may be used to store the desired information and which may be accessed by the computing device 500. The communication media typically embodies computer-readable instructions, data structures, program modules or other data in a modulated data signal, such as a carrier wave or other transport mechanism, and includes any information delivery media.

The memory 512 includes computer-storage media in the form of volatile and/or nonvolatile memory. The memory 512 may be removable, non-removable, or a combination thereof. Examples of hardware devices include solid-state memory, hard drives, optical-disc drives, etc. The computing device 500 includes one or more processor(s) 514 that read data from various entities such as the memory 512 or the I/O components 520. The presentation component(s) 516 present data indications to the user or other device.

The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that the present disclosure is one well adapted to attain all the ends and objects set forth above, together with other advantages which are obvious and inherent to the system 100 and method. It will be understood that certain features and subcombinations are of utility and may be employed without reference to other features and subcombinations. This is contemplated by and is within the scope of the claims.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. Moreover, although the terms “step” and/or “block” may be used herein to connote different elements of methods employed, the terms should not be interpreted as implying any particular order among or between various steps disclosed herein unless and except when the order of individual steps is explicitly described. The examples herein are intended in all respects to be illustrative rather than restrictive. In this sense, alternative examples or implementations can become apparent to those of ordinary skill in the art to which the present subject matter pertains without departing from the scope hereof.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the preceding detailed description is not to be taken in the limiting sense, and the scope of embodiments is defined by the appended claims and their equivalents.

1. A method for prioritizing telecommunications subscribers based on collected data, the method comprising:
collecting telecommunications data comprising voice call metadata;
encrypting the collected telecommunications data;
processing the telecommunications data to determine a connectivity score, wherein the connectivity score is based on a frequency of interactions between each subscriber and one or more other subscribers within a predetermined timeframe; and
applying the connectivity score to a subscriber's profile.

2. The method of claim 1, wherein the voice call metadata indicates a connection between one or more telecommunications subscribers.

3. The method of claim 1, further comprising, based on the connectivity score, prioritizing a plurality of subscriber profiles.

4. The method of claim 3, wherein subscribers with higher connectivity scores receive a higher priority.

5. The method of claim 1, wherein the collected telecommunications data comprises one or more of a frequency of communications between subscribers, duration of voice calls, and type of communication.

6. The method of claim 1, wherein the connectivity score is continuously updated as additional telecommunications data is collected.

7. The method of claim 1, wherein processing the data to determine the connectivity score includes assigning a higher weight to connections involving a number of interactions that exceeds a predetermined interaction threshold or a time of interactions that exceeds a predetermined time threshold.

8. The method of claim 1, wherein the connectivity score identifies subscribers with a high priority to receive targeted marketing or service promotions.

9. The method of claim 1, further comprising generating a visual representation of a connectivity network of subscribers, based on the telecommunications data and the connectivity score.

10. A system for prioritizing telecommunication subscribers, the system comprising:
one or more processors; and
one or more computer-readable media storing computer-usable instructions that, when executed by the one or more processors, cause the one or more processors to:
collect telecommunications data comprising user equipment (UE) communication metadata;
encrypt the collected telecommunications data;
process the telecommunications data to determine a connectivity score, wherein the connectivity score is based on a frequency of interactions between each subscriber and one or more other subscribers within a predetermined timeframe; and
apply the connectivity score to a subscriber's profile.

11. The system of claim 10, wherein the UE communication metadata comprises voice call data, including a call duration and a time of call.

12. The system of claim 10, wherein the UE communication metadata comprises text message data, including a frequency of text messages sent and received.

13. The system of claim 10, wherein the collected telecommunications data comprises one or more of frequency of communications between subscribers, duration of voice calls, and type of communication.

14. The system of claim 10, wherein the one or more processors categorize subscriber interactions based on a type of communication, including a voice call type and a text message type.

15. The system of claim 10, wherein the one or more processors apply a weighing component to different types of communications, wherein voice call types and text message types contribute differently to the connectivity score.

16. Computer-readable storage media having computer-executable instructions embodied thereon that, when executed by one or more processors, cause the one or more processors to:
collect telecommunications data comprising user equipment (UE) communication metadata;
encrypt the collected telecommunications data;
process the telecommunications data to determine a connectivity score, wherein the connectivity score is based on a frequency of interactions between each subscriber and one or more other subscribers within a predetermined timeframe; and
apply the connectivity score to a subscriber's profile.

17. The computer-readable storage media of claim 16, wherein the one or more processors identify subscribers with high connectivity scores as potential network influencers.

18. The computer-readable storage media of claim 16, wherein the one or more processors prioritize subscribers for customer support services based on the connectivity score.

19. The computer-readable storage media of claim 16, wherein the one or more processors collect both outgoing and incoming communication data for each subscriber.

20. The computer-readable storage media of claim 16, wherein the one or more processors generate alerts when a subscriber's connectivity score exceeds a predefined threshold, indicating a high level of network activity.
